(19) United States
(12) Patent Application Publication
(10) Pub. No.: US 2017/0273344 A1
(43) Pub. Date: Sep. 28, 2017

(54) OILY FORMULATION COMPRISING AT LEAST ONE PROBIOTIC BACTERIUM

(71) Applicant: VESALE PHARMA SA, NOVILLE-SUR-MEHAIGNE (BE)

(72) Inventors: JOHAN HENRI HERMAN QUINTENS, HOEGAARDEN (BE); JEHAN LIENART VAN LIDTH DE JEUDE, NOVILLE-SUR-MEHAIGNE (BE)

(21) Appl. No.: 15/504,799

(22) PCT Filed: Aug. 27, 2015
(86) PCT No.: PCT/EP2015/069591

§ 371 Date: Feb. 17, 2017

(30) Foreign Application Priority Data
Aug. 28, 2014 (BE) 2014/0639

(51) Int. Cl. A23L 33/135; A23L 33/115; A23P 10/30; A23L 29/10

(52) U.S. Cl. CPC A23L 33/135; A23L 29/10; A23L 33/115; A23P 10/30; A23V 2002/00

(57) ABSTRACT

An oily formulation comprising at least one probiotic bacterium and comprising a first oily phase comprising at least one saturated or hydrogenated vegetable oil in which is incorporated said at least one probiotic bacterium, a second oily phase comprising at least one polyunsaturated vegetable oil different from said saturated or hydrogenated vegetable oil, and at least one dispersant.

The present invention relates to an oily formulation comprising at least one probiotic bacterium and comprising:
a first oily phase comprising at least one saturated or hydrogenated vegetable oil into which is incorporated said at least one probiotic bacterium,
a second oily phase comprising at least one polyunsaturated vegetable oil different from said saturated or hydrogenated vegetable oil, and
at least one dispersant.

The oily formulation is known from document WO2010/103374 which discloses the suspension of probiotic bacteria either coated or not at the surface in an oily phase of the olive oil, corn oil or further sesame oil type. This suspension of probiotic bacteria in an oily phase has the purpose of ensuring stability of the probiotic bacteria over time in order to maintain a viability as high as possible while notably avoiding that they precipitate, aggregate or form a sediment.

Document US2012/039998 also discloses an oily formulation comprising at least one probiotic bacterium.

Unfortunately, a formulation such as the one described in document WO2010/103374 or in document US2012/039998 only gives the possibility of partly avoiding the precipitation, aggregation and sedimentation problems of probiotic bacteria, for which a significant mortality is observed over time, this even if the probiotic bacteria have been coated beforehand before being put in solution in the oily phase and that the latter is kept under specific optimum temperature conditions and with stirring. These problems are moreover commonly encountered during the suspension of probiotic bacteria in an oil. Indeed, it is well known, that under the force of gravity, probiotic bacteria precipitate and form a precipitate which cannot be used since it consists essentially of non-viable probiotic bacteria. Finally, homogeneization of present suspensions of probiotic bacteria is particularly difficult to obtain from the movement that the probiotic bacteria tend to precipitate over time, which causes a significant mortality thereof.

Therefore there exists a real need for providing a formulation which may be stable and homogeneous over time while setting aside the precipitation, aggregation and sedimentation problems of probiotic bacteria, these problems being responsible for a significant mortality of the latter. It is also important to provide a homogenous formulation which gives the possibility of maintaining the properties of probiotic bacteria without alteration of the latter. Finally, a formulation should be provided which may be kept at room temperature without the oily phase solidifying and without having to produce permanently or at regular intervals, a stirring of the formulation aiming at limiting the precipitation of probiotic bacteria.

In order to solve these problems inherent to present oily formulations containing probiotic bacteria, provision is made according to the invention, for a formulation as indicated initially, characterized in that said first oily phase is formed by a mixture of a hydrogenated palm oil and of a hydrogenated coconut oil, said mixture having a melting temperature comprised between 20° C. and 30° C. and being present in an amount ranging from 2 to 5% by weight based on the total weight of said formulation.

By the terms of “!into which is incorporated said at least one probiotic bacterium”, is meant in the sense of the present invention, that said at least one probiotic bacterium is found in said first oily phase, which then forms an oily carrier for said probiotic bacterium which remains included therein even upon mixing with said second oily phase. This oily carrier is not a true coating of said at least one probiotic bacterium but actually an oily phase into which may be incorporated probiotic bacteria coated beforehand (for example with the same oil as the one forming said first oily phase).

Within the scope of the present invention, it was determined, for an amount by weight of a first oily phase comprised between 2 and 5% based on the total weight of the formulation, that this first apolar oily phase formed by the mixture of a hydrogenated palm oil and of a hydrogenated coconut oil (this mixture being made so that it has a melting temperature comprised between 20° C. and 30° C.) gives the possibility:
of ensuring that the obtained formulation is stable and homogeneous over time (no sedimentation, no precipitation, no aggregation of the probiotic bacteria),
of ensuring maintaining of the properties of probiotic bacteria without altering the latter over time,
of ensuring that the obtained formulation does not solidify neither at room temperature, nor at preservation temperatures of for example 15° C. and 4° C.,
of ensuring high viability of the probiotic bacteria over time, i.e. ensuring a viability of the order of at least 10⁶ CFU/ml to 10¹⁰ CFU/ml over time.

Moreover, it was shown, that in the presence of a dispersant, the dispersion of a first oily phase comprising at least one saturated or hydrogenated vegetable oil and into which is incorporated at least one probiotic bacterium in at least in a second oily phase comprising at least one polyunsaturated vegetable oil contributes to solving the problems mentioned above. Indeed, it was shown that such an oily formulation as a dispersion according to the invention gives the possibility of avoiding the precipitation, aggregation and sedimentation problems of probiotic bacteria so that the obtained oily formulation is stable and homogeneous over time, while preserving the properties of probiotic bacteria which are not at all altered, this without having to produced permanently or at regular intervals stirring of the formulation aiming at limiting the precipitation of probiotic bacteria.

According to the invention, it was determined that the presence of a dispersant gives the possibility of producing a dispersion of a first oily phase based on a saturated or hydrogenated vegetable oil comprising at least one probiotic bacterium in a second oily phase comprising a polyunsaturated vegetable oil, each of the oily phases comprising fats of different natures so as to maintain the viability of the probiotic bacteria without altering the properties thereof while avoiding the problems related to precipitation and/or aggregation of the latter within the oily formulation. Further, according to the invention, these problems are solved durably, for example during a shelf life of at least two months at room temperature and without having to stir the obtained formulation at regular intervals in order to avoid precipitation of the probiotic elements.

More particularly, the dispersant ensures the dispersion of the first oily phase consisting of a saturated or hydrogenated vegetable oil incorporating probiotic bacteria in the second oily phase so that the probiotic bacteria incorporated into the first oily phase do not precipitate but remain dispersed in the second more lightweight oily phase, i.e. an unsaturated oil, comprising a polyunsaturated vegetable oil. Therefore, from the moment that the probiotic bacteria are incorporated into the first oily phase and that they do not precipitate by the dispersion of the first oily phase in the second oily phase, their viability as well as their properties are not altered.

Moreover, according to the invention, the probiotic bacteria are incorporated into a first oily phase based on a saturated or hydrogenated vegetable oil, which is particularly stable from the moment that it has, following hydrogenation, less double bonds responsible for the instability of the oils.

Advantageously, said oily formulation has a dynamic viscosity comprised between 0.1 Pa·s and 0.35 Pa·s, preferably a dynamic viscosity of 0.18 Pa·s, preferentially a dynamic viscosity of 0.15 Pa·s at a temperature of 15° C. (viscosity measured with a Brookfield viscosimeter, version RVT, series 611).

It was determined that such a viscosity obtained by the presence of two oily phases of distinct natures is adequate in order to avoid the precipitation problems of probiotic bacteria and maintain high viability of the latter, i.e. a viability of at least 10⁶ CFU/ml of formulation and ranging up to 10¹⁰ CFU/ml of formulation. Further, such a viscosity gives the possibility of maintaining the formulation in the liquid state at temperatures of the order of 15 to 17° C. This gives the possibility of keeping the formulations according to the invention at relatively low temperatures without solidifying the oils forming the first and second oily phases.

Preferably, said at least one dispersant is a lipophilic non-ionic surfactant selected from the group formed by polysorbates, lecithin, sorbitans, sorbitan esters and mixtures thereof.

Unexpectedly, while it is well known that the presence of dispersants in a formulation comprising probiotic bacteria has a negative impact on the latter in terms of viability and in terms of preservation of their properties, it was determined that a dispersant of the lipophilic non-ionic surfactant type (polysorbates, lecithin, sorbitans, sorbitan esters or further mixtures thereof) does not have a negative impact on probiotic bacteria. Indeed, it was determined, within the scope of the present invention, that this type of dispersant neither alters the viability of the probiotic bacteria nor their properties, for example their capability of regulating intestinal flora.

Advantageously, said at least one dispersant is present in an amount ranging from 0.5 to 2% by weight based on the total weight of said formulation.

Such a dispersant, for example present in such an amount by weight based on the total weight of the formulation was determined, within the scope of the present invention, as being adequate for ensuring dispersion of the first oily phase in the second oily phase in order to ensure that the probiotic bacteria incorporated in said first oily phase do not precipitate and retain a high viability of the order of at least 10⁶ CFU/ml of formulation and ranging up to 10¹⁰ CFU/ml of formulation.

Preferentially, said at least one saturated or hydrogenated vegetable oil has a peroxide index of less than 5 mEq O₂/kg.

Such a peroxide index of the saturated or hydrogenated vegetable oil of the first oily phase gives the possibility of preventing degradation of the probiotic bacteria and ensures proper incorporation of the probiotic bacteria in said first oily phase.

Advantageously, said at least one polyunsaturated vegetable oil is selected from the group formed by soybean oil, canola oil, sunflower oil, macadamia oil, groundnut oil, grape pip oil, pumpkin seed oil, flax oil, olive oil, corn oil, safflower oil, sesame oil, pine kernel oil, conjugate linoleic acid, evening primrose oil, almond oil, peach kernel oil, apricot kernel oil, nut oil, rapeseed oil, raspberry seed oil, blueberry seed oil, cranberry seed oil and other fruit seed oils, fractionated coconut oil and mixtures thereof.

Advantageously, said at least one polyunsaturated vegetable oil is present in an amount of more than 90% by weight based on the total weight of said formulation.

Such proportions of each of the oils respectively forming the first and the second oily phase were determined as being adequate so that the first oily phase is dispersed in an optimal way in the second oily phase, i.e. so that the probiotic bacteria do not precipitate but remain dispersed in the second oily phase when they are incorporated with the first oily phase.

Preferentially, said at least one probiotic bacterium is a probiotic bacterium either microencapsulated or not, either coated or not.

According to the invention, before being incorporated into said first oily phase, the probiotic bacteria may be coated or microencapsulated beforehand, which further reinforces viability.

Preferably, said at least one probiotic bacterium has a particle size of less than 600 μm.

Advantageously, said at least one probiotic bacterium is present in said formulation in an amount from 10⁶ to 10¹⁰ CFU/ml of formulation.

Preferably, said formulation further comprises an additive selected from the group consisting of antioxidants, stabilizers, thickeners, nutrients, fatty acids and mixtures thereof.

For example, flavonoids, carotenoids, tocotrienol, tocopherol or further terpenes may be used as antioxidants within the scope of the present invention. These agents contribute to the stability of the formulation by giving the possibility of removing the oxidation problems.

Vegetable sources of omega 3, of fish or krill oil, sources of omega 6, monoglycerides of fatty acids or further diglycerides of fatty acids may, as for them be used as additional fatty acids.

Beeswax may be used as a thickener.

Monosaccharides, polysaccharides, amino acids, peptides, proteins, vitamins, yeast extracts, halide salts of an alkaline metal or of an earth-alkaline metal, minerals, glycerol, zinc acetate, zinc chloride, zinc lactate, ascorbic acid, citric acid or further milk fat may be used as nutrients.

Other embodiments of the formulation according to the invention are indicated in the appended claims.

The object of the present invention is also a method for making an oily formulation comprising at least one probiotic bacterium, said method comprising the steps:
preparing a pre-mix by mixing and incorporating said at least one probiotic bacterium in a first oily phase formed by a mixture of a hydrogenated palm oil and a hydrogenated coconut oil, said mixture having a melting temperature comprised between 20° C. and 30° C. and being present in an amount ranging from 2 to 5% by weight based on the total weight of said formulation, and
mixing said pre-mix prepared beforehand in a second oily phase comprising at least one polyunsaturated vegetable oil with addition of at least one dispersant.

Preferably, according to the method in accordance with the invention, a step for microencapsulation or coating of said at least one probiotic bacterium is carried out before said step for preparing a pre-mix.

Advantageously, said coating step is carried out by applying, for example by spraying, a coating being selected from the group consisting of alginate, chitosan, pectin, pullulan, gelatin, carrageenan, agar-agar, cellulose, hemicellulose, ethylcellulose, carboxycellulose, and mixture thereof.

Preferably, the method according to the invention comprises an additional step for conditioning said formulation, for example by encapsulation in a soft gelatin capsule, by filling in an ampoule or by filling a hard gelatin capsule, the core of which is liquid.

Other embodiments of the method according to the invention are indicated in the appended claims.

The present invention also deals with the use of a formulation according to the invention for making soft gelatin capsules or for filling in an ampoule or for filling a hard gelatin capsule, the core of which is liquid.

Other embodiments for using a formulation according to the invention are indicated in the appended claims.

### EXAMPLES

### 1. Formulation According to the Invention

Table 1 below mentions the amounts of the different compounds for 100 ml of an oily formulation according to the invention:

TABLE 1

| Compound | Amount | | Function |
|---|---|---|---|
| Sunflower oil | 94 | ml | Second oily phase |
| Saturated or hydrogenated | 2.5 | ml | First oily phase |
| coconut-palm oil (40/60) | | | |
| Lactobacillus rhamnosus | 1 | g | Probiotic bacterium |
| Sorbitan monolaurate | 1 | g | A lipophilic non-ionic |
| | | | surfactant (dispersant) |
| Alpha-tocopherol acetate | 0.2 | g | Antioxidant |
| Lycopene | 0.04 | g | Antioxidant and coloring agent |
| Cholecalciferol | 0.001 | g | Vitamin D3 source |

The probiotic bacteria Lactobacillus rhamnosus are incorporated into the first oily phase consisting in a 40/60 mixture of hydrogenated coconut oil and of hydrogenated palm oil in order to form a pre-mix for which the melting temperature is comprised between 20° C. and 30° C., which is then dispersed, by means of the presence of sorbitan monolaurate (dispersant), in a second oily phase consisting in a polyunsaturated oil which is sunflower oil.

Additives of the antioxidants and/or coloring agent type (alpha-tocopherol acetate, lycopene) and a D3 vitamin source are also added according to this embodiment of a formulation according to the invention.

### 2. Viability of the Probiotic Bacteria in a Formulation According to the Invention

Tests were conducted in order to measure over time the viability of probiotic bacteria for a formulation as described in example 1 and kept at two different temperatures (4° C. and 25° C.), this formulation never being subject to any stirring except just before the taking of the analyzed sample.

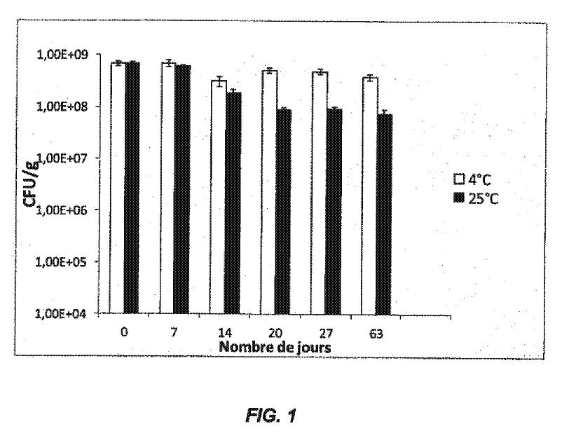

Three repetitions were carried out for each measurement of the viability of the probiotic bacteria (CFU/g). These viability measurements of the probiotic bacteria were carried out after 7, 14, 20, 27 and 63 days following the preparation of the formulation according to the invention. FIG. 1 resumes the obtained results.

As this may be seen, without any stirring, the viability of probiotic bacteria present in a formulation according to the invention is particularly high. Indeed, when the oily formulation is kept at a temperature of 4° C., a survival rate of 73% and of 58% are respectively reported after 27 and 63 days.

### 3. Comparative Stability Tests of Compositions According to the Invention Comprising Variable Amounts (% By Weight) of the First Oily Phase (Saturated or Hydrogenated Vegetable Oil)

Comparative tests were carried out by varying exclusively for a same basic formulation, the amount by weight of the first oily phase. Amounts by weight (% by weight) of 2.5%, 6% and 8% based on the total weight of the formulation were tested in order to determine whether the obtained formulation remains in a stable liquid form, i.e. if the obtained formulation does not solidify in which case the properties and the viability of the probiotic bacteria would be altered.

These tests were conducted according to three different temperatures, i.e. by exposing the formulations formed at 4° C., at 15° C. and at 25° C. for 24 h. The obtained results are resumed in Table 3 below while Table 2 resumes the different tested formulations.

TABLE 2

| | % by weight | | |
|---|---|---|---|
| | Formulation | | Formulation |
| | 1 | Formulation 2 | 3 |
| Sunflower oil | 92.47 | 88.97 | 86.97 |
| Mixture of hydrogenated | 2.5 | 6 | 8 |
| coconut oil and of | | | |
| hydrogenated palm oil, the | | | |
| mixture having a melting | | | |
| temperature comprised | | | |
| between 20° C. and 30° C. | | | |
| Beeswax | 2.5 | 2.5 | 2.5 |
| Lactobacillus rhamnosus | 1.48 | 1.48 | 1.48 |
| Sorbitan monolaurate | 0.85 | 0.85 | 0.85 |
| Alpha-tocopherol acetate | 0.2 | 0.2 | 0.2 |

TABLE 3

| | Formulation 1 | Formulation 2 | Formulation 3 |
|---|---|---|---|
| 4° C. | liquid phase | solid phase | solid phase |
| 15° C. | liquid phase | solid phase | solid phase |
| 25° C. | liquid phase | semi-solid phase | solid phase |

As this may be seen, after 24 h, only the formulation 1 according to the invention comprising the first oily phase is an amount of 2.5% by weight based on the total weight of the formulation is maintained in a liquid and stable form (no precipitation, no aggregation, no sedimentation of probiotic bacteria) at temperatures of 4° C., 15° C. and 25° C. On the other hand, it was observed that the formulations 2 and 3 comprising 6 and 8% by weight respectively of a first oily phase based on the total weight of the formulation appear in a semi-solid or solid form at these same temperatures after 24 h.

4. The Formulation According to the Invention: Tests with Different Second Oily Phases (Polyunsaturated Vegetable Oils)

Several formulations were tested in order to determine whether, for a same first oily phase formed with a mixture of hydrogenated palm oil and hydrogenated coconut oil (the mixture having a melting temperature comprised between 20° C. and 30° C.), diverse second oily phases comprising a polyunsaturated vegetable oil may be suitable. It was determined, for each formulation, whether it remains in a stable liquid form (no precipitation, no aggregation, no sedimentation of probiotic bacteria) at 4° C., 15° C. and 25° C. after 24 hours.

The obtained results are resumed in Table 5 while Table 4 resumes the different tested formulations.

As this may be seen, regardless of the polyunsaturated vegetable oil forming the second oily phase, stable liquid formulations (no precipitation, no aggregation, no sedimentation of probiotic bacteria) are systematically observed after 24 h for the temperatures of 15° C. and 25° C. Let us note that at the temperature of 4° C., the formulations 5 and 8 appear in a semi-liquid form. Moreover, it emerges from this example that regardless of the dispersant used, stable liquid formulations are systematically obtained at each of the tested temperatures.

TABLE 4

| | % by weight | | | | |
|---|---|---|---|---|---|
| | Formulation 4 | Formulation 5 | Formulation 6 | Formulation 7 | Formulation 8 |
| Second oily phase | Sunflower | Olive oil | Mixture of | Groundnut | Soybean oil |
| | oil | 91.32 | oils* | oil | 91.32 |
| | 92.47 | | 92.47 | 91.32 | |
| First oily phase: mixture | 2.5 | 2.5 | 2.5 | 2.5 | 2.5 |
| of hydrogenated coconut | | | | | |
| oil and hydrogenated | | | | | |
| palm oil, the mixture | | | | | |
| having a melting | | | | | |
| temperature comprised | | | | | |
| between 20° C. and 30° C. | | | | | |
| Beeswax | 2.5 | 2.5 | 2.5 | 2.5 | 2.5 |
| Lactobacillus rhamnosus | 1.48 | 1.48 | 1.48 | 1.48 | 1.48 |
| Dispersant | Sorbitan | Lecithin | Sorbitan | Lecithin | Lecithin |
| | monolaurate | 2 | monolaurate | 2 | 2 |
| | 0.85 | | 0.85 | | |
| Alpha-tocopherol acetate | 0.2 | 0.2 | 0.2 | 0.2 | 0.2 |

*MCT (Medium Chain Triglyceride)

TABLE 5

| | Formulation 4 | Formulation 5 | Formulation 6 | Formulation 7 | Formulation 8 |
|---|---|---|---|---|---|
| 4° C. | Liquid | Semi-liquid | Liquid | Liquid | Semi-liquid |
| | phase | phase | phase | phase | phase |
| 15° C. | Liquid | Liquid | Liquid | Liquid | Liquid |
| | phase | phase | phase | phase | phase |
| 25° C. | Liquid | Liquid | Liquid | Liquid | Liquid |
| | phase | phase | phase | phase | phase |

It is quite understood that the present invention is by no means limited to the embodiments described above and that many modifications may be made thereto without departing from the scope of the appended claims.

1. An oily formulation, comprising:
a first oily phase comprising at least one vegetable oil in which is incorporated at least one probiotic bacterium, wherein the at least one vegetable oil is selected from the group consisting of a saturated vegetable oil and a hydrogenated vegetable oil;
a second oily phase comprising at least one polyunsaturated vegetable oil different from said at least one vegetable oil, and;
at least one dispersant; and
said formulation being characterized in that said first oily phase is formed by a mixture of a hydrogenated palm oil and of a hydrogenated coconut oil, said mixture having a melting temperature between 20° C. and 30° C. and being present in an amount ranging from 2% to 5% by weight based on a total weight of said formulation.

2. The oily formulation according to claim 1, characterized in that the oily formulation has a dynamic viscosity between 0.1 P·.s and 0.35 Pa·s.

3. The oily formulation according to claim 1, characterized in that said at least one dispersant is a lipophilic non-ionic surfactant selected from the group consisting of polysorbates, lecithin, sorbitans, sorbitan esters and mixtures thereof.

4. The oily formulation according to claim 1, characterized in that said at least one dispersant is present in an amount ranging from 0.5 to 2% by weight based on the total weight of said formulation.

5. The oily formulation according to claim 1, characterized in that said at least one polyunsaturated vegetable oil is selected from the group consisting of soybean oil, canola oil, sunflower oil, macadamia oil, groundnut oil, grape pip oil, pumpkin seed oil, flax oil, olive oil, corn oil, safflower oil, sesame oil, pine kernel oil, conjugate linoleic acid, evening primrose oil, almond oil, peach kernel oil, apricot kernel oil, nut oil, rapeseed oil, raspberry seed oil, blueberry seed oil, cranberry seed oil and other fruit seed oils, fractionated coconut oil and mixtures thereof.

6. The oily formulation according to claim 1, characterized in that said at least one polyunsaturated vegetable oil is present in an amount of more than 90% by weight based on the total weight of said formulation.

7. The oily formulation according to claim 1, characterized in that said at least one probiotic bacterium is a probiotic bacterium selected from the group consisting of a microencapsulated probiotic bacterium and a coated probiotic bacterium.

8. The oily formulation according to claim 1, characterized in that said at least one probiotic bacterium has a particle size of less than 600 μm.

9. The oily formulation according to claim 1, characterized in that said at least one probiotic bacterium is present in said formulation in an amount of 106 to 1010 CFU/ml of formulation.

10. The oily formulation according to claim 1, characterized in that it further comprises an additive selected from the group consisting of antioxidants, stabilizers, thickeners, nutrients, fatty acids and mixtures thereof.

11. A method for manufacturing an oily formulation comprising at least one probiotic bacterium, said method comprising the steps:
preparing a pre-mix formulation by mixing and incorporating at least one probiotic bacterium into a first oily phase formed with a mixture of hydrogenated palm oil and hydrogenated coconut oil, said mixture having a melting temperature between 20° C. and 30° C. and being present in an amount ranging from 2% to 5% by weight based on a total weight of said pre-mix formulation, and
mixing said pre-mix formulation into a second oily phase comprising at least one polyunsaturated vegetable oil with addition of at least one dispersant.

12. The manufacturing method according to claim 11, characterized in that it comprises a step of preparing said at least one probiotic bacterium prior to said step preparing the pre-mix formulation that is selected from the group consisting of a microencapsulation step and a coating step.

13. The manufacturing method according to claim 12, characterized in that said coating step is carried out by applying a coating selected from the group consisting of alginate, chitosan, pectin, pullulan, gelatin, carrageenan, agar-agar, cellulose, hemicellulose, ethylcellulose, carboxycellulose, and mixtures thereof.

14. The manufacturing method according to claim 11, further comprising:
conditioning said oily formulation by encapsulating in a soft gelatin capsule.

15. The manufacturing method according to claim 14. characterized in that the oily formulation has a dynamic viscosity between 0.1 Pa·s and 0.35 Pa·s.

16. The oily formulation according to claim 2, characterized in that the oily formulation has a dynamic viscosity of 0.18 Pa·s.

17. The oily formulation according to claim 2, characterized in that the oily formulation has a dynamic viscosity 0.15 Pa·s at a temperature of 15° C.

18. The manufacturing method according to claim 13, characterized in that applying step comprises spraying the coating.

19. The manufacturing method according to claim 11, further comprising:
conditioning said oily formulation by filling in an ampoule, or by filling a hard gelatin capsule, the core of which is liquid.

20. The manufacturing method according to claim 14, characterized in that said at least one dispersant is a lipophilic non-ionic surfactant selected from the group consisting of polysorbates, lecithin, sorbitans, sorbitan esters and mixtures thereof.
